(19) United States
(12) Patent Application Publication
(10) Pub. No.: US 2025/0147158 A1
(43) Pub. Date: May 8, 2025

(54) LIDAR DEVICE

(71) Applicant: Robert Bosch GmbH, Stuttgart (DE)

(72) Inventors: Annette Frederiksen, Renningen (DE); Mustafa Kamil, Ludwigsburg (DE)

(21) Appl. No.: 17/839,625

(22) Filed: Jun. 14, 2022

(30) Foreign Application Priority Data
Jun. 16, 2021 (DE) 10 2021 206 122.2

(51) Int. Cl. G01S 7/4863; G01S 7/481; G01S 7/484; G01S 7/4865

(52) U.S. Cl. CPC G01S 7/4863; G01S 7/4817; G01S 7/484; G01S 7/4865

(57) ABSTRACT

A LIDAR device for scanning a field of vision with the aid of an emitter module that includes an emitter pixel matrix made up of emitter pixel columns and emitter pixel rows and with the aid of a detector module that includes a detector pixel matrix made up of detector pixel columns and detector pixel rows. Individual or all emitter pixels of the emitter pixel matrix and/or individual or all detector pixels of the detector pixel matrix is/are selectively activatable.

### FIELD

The present invention relates to a LIDAR device for scanning a field of vision with the aid of an emitter module that includes an emitter pixel matrix made up of emitter pixel columns and emitter pixel rows and with the aid of a detector module that includes a detector pixel matrix made up of detector pixel columns and detector pixel rows.

### BACKGROUND INFORMATION

LIDAR devices of this type are conventional. Current LIDAR devices are usually designed as rotating macroscanners, microscanners or flash systems. At present, rotating or scanning LIDAR devices having at least one flashed subarea, in particular, such as for example a line flash, draw special attention to themselves.

A flash design of this type is also conventional. However, such systems also have certain disadvantages. For example, in particular during temporally correlated scanning of the same horizontal solid angle in the field of vision in the case of strongly reflective objects, such as for example retroreflectors (street signs, rear lights, and the like), this may result in undesirable image artifacts. This so-called crosstalk is due to a saturation of the detector in the detector module of the LIDAR device, since the detector is designed to detect very dark objects (objects having a very low reflectivity). If well reflecting objects are then locally continuously (for example in an emitter pixel column) and temporally simultaneously illuminated, temporally strongly correlated reflection of optical power occurs in the detector module. This optical power results due to scattering and multiple reflection in the detector module in a crosstalk between individual detector pixels, photons resulting in misdetections in the wrong solid angle of the field of vision along the detector pixel column. In the 3D point cloud output with the aid of the LIDAR device, a continuous wall is to be seen below and above the strongly reflecting object that does not exist in reality, however. A misdetection of this type then represents a not irrelevant risk for the traffic safety, in particular in LIDAR devices installed in (autonomously traveling) vehicles.

### SUMMARY

According to the present invention, a LIDAR device is provided, in which individual or all emitter pixels of the emitter pixel matrix and/or individual or all detector pixels of the detector pixel matrix are selectively activatable.

The LIDAR device has the advantage that optical crosstalk and misdetection may thus be minimized.

It is possible for LIDAR devices, in particular those that are designed to detect particularly dark objects (objects having a low reflectivity), to become saturated quickly in the case of bright objects (objects having a high reflectivity). This saturation results in an optical crosstalk in the detector module due to scattered light formation. In order to prevent this saturation effect, the individual emitter pixels and/or the individual detector pixels are now activatably designed. The emitted and/or detected optical power is reducible by selectively activating specific emitter pixels and/or specific detector pixels. An adaptive adaptation of the generated amount of data (density of the 3D point cloud) may thus be achieved. Non-relevant areas of the real world (for example the sky) may be omitted.

Likewise, the detection probability of the LIDAR device may be increased. It is thus possible to generate any arbitrary illumination pattern for scanning by selectively activating individual emitter pixels and/or detector pixels. The detection probability is improved as compared to the spatially gapless illumination of directly adjacent detector pixels, for example. A crosstalk between adjacent detector pixels is reduced due to their possible spatial separation. There is also the possibility of increasing the detection probability in the same horizontal solid angle. By omitting individual detector pixels, the background noise levels may be emitted at the not actively illuminated spots of a detector pixel row or a detector pixel column. This misdetection rate may then be used (background subtraction) for improving the detection rates at the illuminated spots (having active detector pixels).

A temporal rectification of the power consumption in the laser of the LIDAR device and thus a reduction in the self-heating also result. This, in turn, has advantages for the electromagnetic compatibility (EMC), since fewer temporally concentrated current peaks occur in the LIDAR device.

Finally, omitting specific spatial illumination areas may also result in advantages in the admissible transmission power if this temporally and spatially rectified illumination has a positive effect on eye safety (for example when the pupil perceives less power due to not illuminated pixels).

In accordance with an example embodiment of the present invention, it is also possible that the emitter pixel matrix and/or the detector pixel matrix is/are selectively activatable in such a way that the scanning of the field of vision is made up of at least two complementary emitter pixel patterns and/or at least two complementary detector pixel patterns.

The crosstalk may be initially reduced in this case by a temporally and spatially smart design of the emitter pixel pattern. Strong reflectors are in particular illuminated in a not spatially continuous manner at the same time by the emitter module. Based on this targeted gap formation in the illumination behavior, significantly fewer multiple reflections and scatterings occur in the reception path at the same point in time in each case. The reason for this is the temporally rectified illumination of adjacent areas, by which fewer photons are reflected back at the same point in time. The crosstalk may then also be further reduced by a temporally and spatially smart design of the detector pixel pattern. This happens, for example, by inserting deactivated detector pixels between two active detector pixel areas. The LIDAR device is thus only able to generate an emitter pixel pattern on the transmission side; or it is only able to generate a detector pixel pattern on the reception side; or it is able to generate an emitter pixel pattern as well as a detector pixel pattern on the transmission side and on the reception side. For this reason, a rectification of the optical power incident at the same time and at the same solid angle is achieved.

In one particular specific embodiment of the present invention, the emitter pixel matrix and/or the detector pixel matrix is/are selectively activatable in such a way that the complementary patterns may be generated at the same time or at consecutive points in time.

The rectification of the optical power at any given solid angle may generally take place in two different ways. On the one hand, the optical power of the LIDAR device may be divided between two frames per solid angle, where LIDAR devices of the related art provide for a continuous illumination of a pixel column or pixel row. In a first frame of the two frames, emitter pixels and/or detector pixels may be activated in an alternating emitter pixel pattern and/or an alternating detector pixel pattern. In a second frame of the two frames, the illumination gaps left behind in the first frame in the point cloud are then closed. The LIDAR device must then scan twice as fast in order to obtain the scanning rate of the point cloud. In this example, the optical power per solid angle is then halved, which is advantageous with regard to saturation. The optical power may be distributed across more than the two frames of the example described here.

On the other hand, it is possible to provide for the different pixel patterns to be temporally consecutive. In this way, the gap closing in the 3D point cloud may be improved. By designing a pixel pattern that is complementary in each case, the gaps of the pixel pattern may be filled during the further rotation of the transmission path and/or the reception path right in the subsequent time step or angle step.

Alternatively, in accordance with an example embodiment of the present invention, it is advantageously provided that the emitter pixel matrix and/or the detector pixel matrix is/are selectively activatable in such a way that the complementary patterns may be generated as a function of a predetermined environmental condition.

The LIDAR device may then be dynamically adapted to the environmental condition. In this way, the targeted activation of the emitter pixel matrix and/or detector pixel matrix may only take place, for example, if the LIDAR device is (at risk of) going into saturation, i.e., strongly reflecting objects are present in the field of vision. The distribution of the emitter pixel patterns and/or the detector pixel patterns into the scanned areas and gaps may be adapted depending on the situation.

In accordance with an example embodiment of the present invention, it is furthermore very advantageous that the complementary emitter pixel patterns and/or the complementary detector pixel patterns may be generated as a function of the predetermined environmental condition in a temporally and/or spatially delimited manner in the field of vision.

The dynamic activation of the LIDAR device is thus precisely possible. Thus, the distribution of the emitter pixel matrix and/or the detector pixel matrix into illuminated pixels and gaps may then be carried out only if the LIDAR device is (at risk of) going into saturation. This represents a temporally delimited targeted activation of the pixels. A spatially delimited activation is also possible. For example, it is possible to illuminate only portions of the field of vision. This is meaningful in particular if strongly reflecting objects or, for example, larger areas of the sky are part of the field of vision.

According to one preferred specific embodiment of the present invention, it is provided that the emitter pixel matrix and/or the detector pixel matrix is/are selectively activatable in such a way that the complementary emitter pixel patterns and/or the complementary detector pixel patterns are generatable by selectively electronically switching off individual emitter pixels or individual detector pixels.

The LIDAR device may be selectively activated in the transmission path and in the reception path. It is advantageous in this case to electronically switch off the detector pixels that are not in use. This makes possible a clear optical separation of adjacent solid angles and thus a prevention of the crosstalk as well as a considerable reduction in misdetections. It is likewise advantageous to deactivate those detector pixels in particular that are assigned to the deactivated emitter pixels. It is necessary in this case that the transmission path is equipped with a transmission objective that implements a 1:1 depiction, so that individual solid angle areas may be switched on and off on the transmission side. If, however, a mixing objective is used in the transmission path that is a combination of several optical elements, so that a 1:1 depiction of emitter pixels to detector pixels is not possible, the approach according to the present invention is only to be used for the reception path. The loss of optical power resulting therefrom is not a disadvantage in the case of saturation, but rather desirable.

Finally, it is advantageous that the emitter module and/or the detector module each has at least one electronically switchable mask, with the aid of which the complementary emitter pixel patterns or the complementary detector pixel patterns are generatable.

For example, an electronically switchable mask, for example LCDs, may be used in the transmission path to generate the emitter pixel pattern. For this purpose, the mask is placed at a location in the optical transmission path that results in a 1:1 depiction. The pattern that occurred as a result of the mask may be modified in the dark phase of each frame (here the switching times of typical LCD cells are also not a problem), so that the gaps in the pixel pattern may be closed in the subsequent frame. This is advantageous if, for example, the resolution that is switchable on the transmission side is to be increased as compared to the resolution provided by the laser diodes.

Advantageous refinements of the present invention are disclosed herein.

### BRIEF DESCRIPTION OF THE DRAWINGS

Exemplary embodiments of the present invention are explained in greater detail based on the drawings and the description below.

FIG. 1 shows a pixel column according to the related art.

FIG. 2 shows two simultaneous complementary pixel column patterns according to the present invention.

FIG. 3 shows four pixel columns according to the related art.

FIG. 4 shows two simultaneous complementary pixel column patterns each having four columns according to the present invention.

FIG. 5 shows a pixel column according to the related art.

FIG. 6 shows two temporally offset complementary pixel column patterns according to the present invention.

### DETAILED DESCRIPTION OF EXAMPLE EMBODIMENTS

The LIDAR device according to the present invention achieves a rectification of the optical power that is incident on strongly reflecting objects at the same time and at the same solid angle. In the following, two modes that are suitable for slightly varying the angles of the pulses incident on an object, so that gaps are left behind in the transmission path and/or in the reception path in a targeted manner, are elucidated using the example of a pulsed ToF LIDAR device (the use in CW LIDAR devices is also conceivable, however). These gaps may be closed either in the next rotation of a rotor of the LIDAR device via a complementary pixel pattern or directly during the same rotation via adjacent emitter pixels and/or detector pixels, which are activated successively.

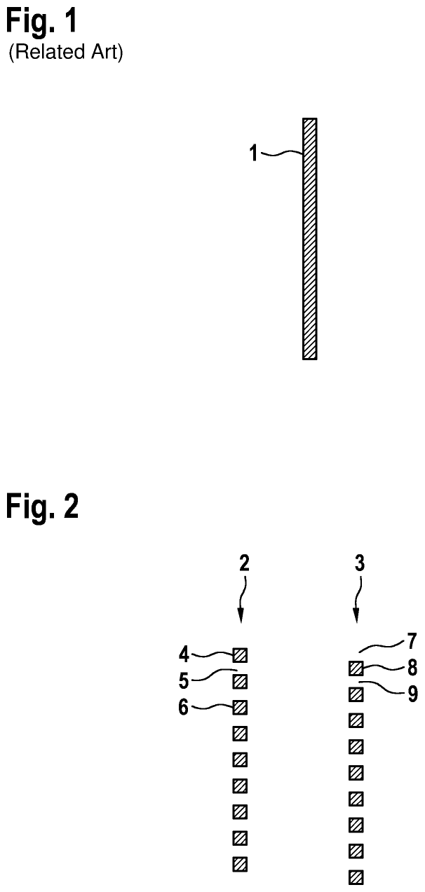

In FIG. 1, a system of the related art is initially shown, in which a first pixel column 1 is illuminated and scanned per solid angle according to the horizontal resolution. This is improved according to the present invention, as shown in FIG. 2, in that the optical power is distributed across a first frame 2 and a second frame 3. This is achieved in that in first frame 2 emitter pixels 4, 6 (and matching detector pixels that are not illustrated) are activated, a deactivated emitter pixel 5 being situated between two activated emitter pixels 4, 6. This emitter pixel pattern continues throughout the emitter pixel column. The gap that is left behind by deactivated emitter pixel 5 in first frame 2 is closed in second frame 3 by activated emitter pixel 8. Vice versa, emitter pixels 7, 9 deactivated in second frame 3 are now in the position of activated emitter pixels 4, 6 of first frame 2. A complementary emitter pixel pattern that is distributed across first and second frame 2, 3 is formed. The distribution of the scanned areas with regard to the gaps may be selected depending on the situation, a varying distribution across the vertical field of vision possibly being used (for example larger areas of the sky, larger gaps on street signs). In the illustrated example, the optical power incident at the same time in the same horizontal solid angle area is halved, which is an advantage with regard to saturation. A distribution across more than two frames 2, 3 is also conceivable.

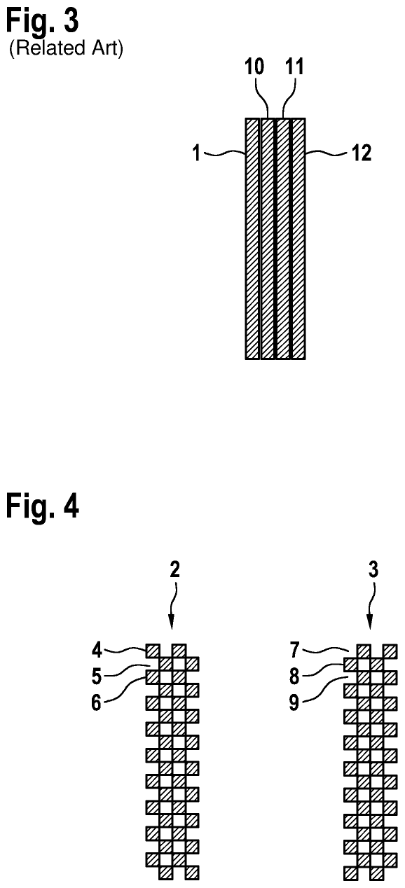

In FIG. 3, a system of the related art is shown, in which in addition to first pixel column 1 a second pixel column 10, a third pixel column 11, and a fourth pixel column 12 are provided. The transmission path and/or the reception path are designed to scan a larger horizontal solid angle. As shown in FIG. 4, first frame 2 and second frame 3 are also provided again with a complementary emitter pixel pattern (and/or a complementary detector pixel pattern that is not illustrated) according to the present invention. A rectification of the optical power per point in time and solid angle may also take place in this case. This variant is advantageous, if, for example, a greater scanning frequency or a slower rotation or scanning frequency is to be achieved due to larger partial scanning.

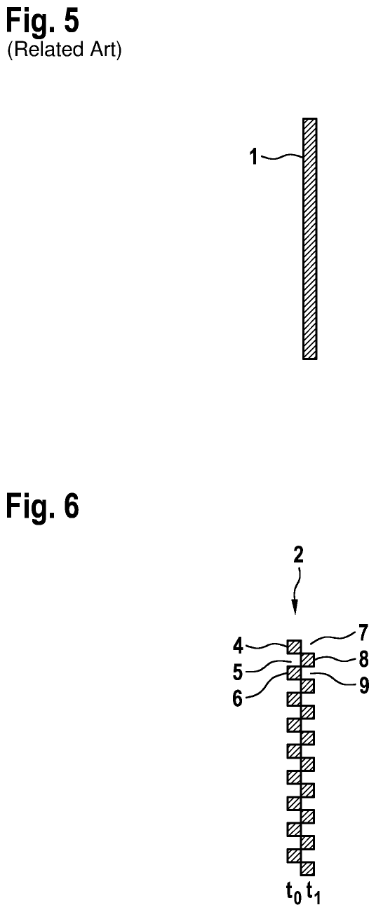

FIG. 5 shows again the system of the related art, in which a first pixel column 1 is illuminated and scanned per solid angle according to the horizontal resolution. In FIG. 6, the second mode according to the present invention is apparent. Here, a pixel column is temporally implemented within first frame 2 by two consecutively (at points in time t₀, t₁) closed and received pixel columns. In this way, the gap closing in the 3D point cloud is improved. By providing complementary emitter pixel patterns (and/or detector pixel patterns), the gaps may be filled directly during the further rotation of the transmission path and/or reception path right in the subsequent time step or angle step. A variable distribution, depending on the situation, of the scanned areas with regard to the gaps may also be used.

The present invention was elucidated by way of example of a pulsed ToF LIDAR device including vertical scanning. The present invention may, however, also be transferred to other LIDAR devices, such as for example row scanners, micromirror systems, or flash systems. The time scanner is in particular implementable analogously to the present invention. 2D micromirror systems may implement corresponding pixel patterns by switching the light source on and off. Flash systems are also analogously implementable by activating individual emitter pixels and/or detector pixels.

Although the present invention has been illustrated and described in greater detail using the preferred exemplary embodiments, the present invention is not limited by the provided examples and other variations may be derived therefrom by those skilled in the art without departing from the protective scope of the present invention.

1-7. (canceled)

8. A LIDAR device for scanning a field of vision, comprising:
an emitter module that includes an emitter pixel matrix made up of emitter pixel columns and emitter pixel rows; and
a detector module that includes a detector pixel matrix made up of detector pixel columns and detector pixel rows;
wherein all emitter pixels of the emitter pixel matrix and/or all detector pixels of the detector pixel matrix are individually selectively activatable.

9. The LIDAR device as recited in claim 8, wherein the emitter pixel matrix and/or the detector pixel matrix is selectively activatable in such a way that the scanning of the field of vision is made up of at least two complementary emitter pixel patterns and/or at least two complementary detector pixel patterns.

10. The LIDAR device as recited in claim 9, wherein the emitter pixel matrix and/or the detector pixel matrix is selectively activatable in such a way that the complementary emitter pixel patterns and/or the complementary detector pixel patterns are generatable at the same time or at consecutive points in time.

11. The LIDAR device as recited in claim 9, wherein the emitter pixel matrix and/or the detector pixel matrix is selectively activatable in such a way that the complementary emitter pixel patterns and/or the complementary detector pixel patterns are generatable as a function of a predetermined environmental condition.

12. The LIDAR device as recited in claim 11, wherein the complementary emitter pixel patterns and/or the complementary detector pixel patterns are generatable as a function of the predetermined environmental condition in a temporally and/or spatially delimited manner in the field of vision.

13. The LIDAR device as recited in claim 9, wherein the emitter pixel matrix and/or the detector pixel matrix is selectively activatable in such a way that the complementary emitter pixel patterns and/or the complementary detector pixel patterns are generatable by selectively electronically switching off individual emitter pixels or individual detector pixels.

14. The LIDAR device as recited in claim 9, wherein the emitter module and/or the detector module each has at least one electronically switchable mask, using which the complementary emitter pixel patterns or the complementary detector pixel patterns are generatable.
